(19) United States
(12) Patent Application Publication
(10) Pub. No.: US 2010/0015325 A1
(43) Pub. Date: Jan. 21, 2010

(54) Method and Apparatus for Applying A Layer of A Second Material To A Layer of a Nanocrystalline First Material

(75) Inventors: Rudolf Peter Muis, KK Sijbekarspel (NL); Brian Coolidge O'Regan, EG Amsterdam (NL)

Correspondence Address: PAUL, HASTINGS, JANOFSKY & WALKER LLP, 875 15th Street, NW, Washington, DC, 20005, US

(73) Assignee: Stitching Energieonderzoek Centrum Nederland

(21) Appl. No.: 12/564,621

(22) Filed: Sep. 22, 2009

Related U.S. Application Data
(62) Division of application No. 10/514,424, filed on May 26, 2005.

(30) Foreign Application Priority Data
May 29, 2002 (NL) 1020701

(51) Int. Cl. B05D 5/12; B05D 1/02; B05D 3/02

(52) U.S. Cl. 427/58; 427/424; 427/314

(57) ABSTRACT

Method for applying a layer of a second material to a layer of a nanocrystalline first material, comprising the steps of (i) providing a layer of a nanocrystalline first material on a horizontal substrate, (ii) providing a liquid containing the second material, (iii) providing a tubular dispensing means to be disposed horizontally and provided with lateral outlet openings, (iv) disposing the dispensing means above the layer of nanocrystalline material, and (v) displacing the dispensing means and the layer of nanocrystalline material relative to each other in lateral horizontal direction of the dispensing means, while simultaneously supplying the liquid with the second material to the dispensing means, and apparatus for performing this method.

The invention relates to a method for applying a layer of a second material to a layer of a nanocrystalline first material.

Such a method is known from European patent application EP-A-1107333 for a photoelectric conversion device, where the manufacture of a work electrode for a photovoltaic element is described.

The work electrode described in this patent application comprises a conductive layer which is applied to a glass substrate and to which are successively applied a first layer of a nanocrystalline titanium dioxide, provided with a dye sensitizer and a second layer of a thiocyanate acting as a charge transfer medium. The second layer is applied in known manner by using an Eppendorf to drip a determined amount of a solution of the thiocyanate in acetonitrile onto the substrate with the first layer, wherein the substrate rests on a heating plate in order to evaporate the solvent.

The known method has the drawback that it is particularly difficult to apply a second layer that is homogenous onto a first layer of a nanocrystalline material in reproducible manner. The thickness of the charge transfer layers described in the cited patent application amounted to between 15 μm and 30 μm.

Another drawback is the long period of time involved in applying a layer of a sufficient width for a photovoltaic element.

A further drawback of the known method is that it is difficult to scale up, i.e. it cannot be readily applied for the manufacture of photovoltaic elements on industrial scale.

It is an object of the invention to provide a method in accordance with which it is possible in reproducible manner to apply a second layer that is homogenous onto a first layer of a nanocrystalline material.

It is a further object to provide a method in accordance with which a layer of a sufficient width for a photovoltaic element can be applied in a short period of time.

It is yet another object to provide a method which can be readily applied for the manufacture of photovoltaic elements on industrial scale.

These goals are achieved with a method of the type stated in the preamble, which according to the invention comprises the steps of (i) providing a layer of a nanocrystalline first material on a horizontal substrate, (ii) providing a liquid containing the second material, (iii) providing a tubular dispensing means to be disposed horizontally and provided with lateral outlet openings, (iv) disposing the dispensing means above the layer of nanocrystalline material, and (v) displacing the dispensing means and the layer of nanocrystalline material relative to each other in lateral horizontal direction of the dispensing means, while simultaneously supplying the liquid with the second material to the dispensing means.

During performing of the fifth step (v) liquid flows from the dispensing means onto the layer of the nanocrystalline material, where the liquid firstly penetrates into the pores of this material and subsequently forms a layer on the material.

The liquid containing the second material to be provided in the second step (ii) is preferably a solution with this second material, from which the second material can be precipitated by evaporation of the solvent, but can also be the second material in liquid phase which solidifies after being applied to the layer of nanocrystalline material.

The invention further relates to an apparatus for performing the above described method, which apparatus according to the invention comprises at least one tubular dispensing means to be disposed horizontally and provided with lateral outlet openings, a liquid container and conduit means for carrying liquid from the liquid container to the at least one dispensing means.

One embodiment of an apparatus according to the invention is provided with displacing means for displacing the dispensing means and the layer of nanocrystalline material relative to each other in lateral horizontal direction of the dispensing means, which displacing means comprise for instance a carrier displaceable in horizontal direction relative to the dispensing means for carrying and displacing a layer of nanocrystalline material in lateral direction relative to the dispensing means.

In an advantageous embodiment the displacing means comprise an XY table.

In an embodiment which is particularly suitable for use in applying a layer of a second material that is provided in dissolved state in a solvent, the apparatus according to the invention is provided with heating means to heat a layer of a nanocrystalline material during performing of the method.

In one embodiment the tubular dispensing means is connected at a first outer end to a first liquid supply line and is closed at a second outer end. In this embodiment the liquid to be dispensed is supplied via the first outer end of the tubular dispensing means and is deposited via the outlet openings onto the layer of nanocrystalline material.

In a subsequent embodiment the tubular dispensing means is connected at a first outer end to a first liquid supply line, and is connected at a second outer end to a liquid circulation line or a second liquid supply line.

This latter embodiment is particularly suitable for use in applying a relatively wide layer. The tubular dispensing means herein forms part of a U-shaped structure, wherein the dispensing means is suspended at a first outer end from a first liquid supply line, and at a second outer end is suspended from a liquid circulation line or from a second liquid supply line.

It has been found that an exceptionally homogenous layer is applied with an apparatus according to the invention wherein the lateral outlet openings are provided in the top side of a horizontally disposed tubular dispensing means.

The tubular dispensing means preferably has a circular outer periphery in vertical cross-section.

A tubular dispensing means with a circular outer periphery has the advantage that the tube required for this purpose is commercially available in the desired sizes, so that the dispensing means can be manufactured in simple manner and at low cost.

The present invention will be elucidated hereinbelow on the basis of an embodiment of an apparatus and with reference to the drawing.

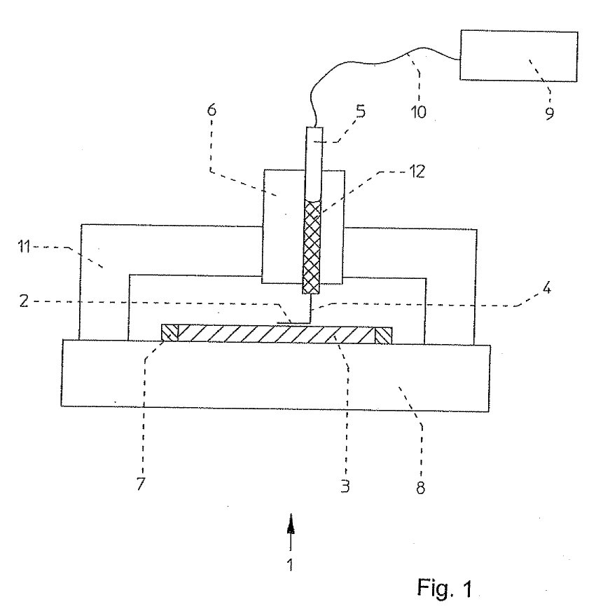

FIG. 1 shows a front view of a simplified view of an embodiment of an apparatus 1 for applying a second layer of a soluble material to a first layer of a nanocrystalline material. The FIGURE shows an L-shaped injection needle, a part 2 of which is arranged horizontally above a horizontally placed copper substrate table 3, and a vertical part 4 of which is connected to a supply container 5 for a solution 12 of a material to be applied. The injection needle 2, 4 has an internal diameter of 0.4 mm. The horizontal part 2 thereof forms the dispensing tube which is closed at its free outer end, and which is provided on its upper side with a number of outlet openings with a diameter of 0.1 mm (not shown). Supply container 5 and L-shaped injection needle 2, 4 are mounted on a height adjusting device 6 for adjusting the distance between the dispensing tube 2 and a substrate with nanocrystalline layer laid on substrate table 3 (not shown).

Substrate table 3 is displaceable in lateral horizontal direction of dispensing tube 2 (perpendicularly of the plane of the drawing) between longitudinal guides 7 over a heating plate 8. The FIGURE further shows another liquid metering pump 9 which is connected with a flexible conduit 10 to supply container 5 and a fixed yoke 11 for suspending the height adjusting device 6. Not shown is a switch box with measuring and control electronics for height adjusting device 6, the temperature adjustment of heating plate 8, the displacement of substrate table 3 and metering pump 9.

It is noted that the described embodiment serves to elucidate the invention, and not to limit the scope of protection of the patent applied for. It is for instance possible to embody the tube part 2 as a horizontal part of a U-shaped injection needle. The width of the homogenous layer laid on the layer of nanocrystalline material is after all determined by the length of the tube part 2, which length is inherently limited, at a determined number of outlet openings of a determined diameter, by the internal diameter of tube part 2. The use of a U-shaped injection needle achieves that within these limitations this length is doubled, wherein liquid is fed via both outer ends to the horizontal part. It is further possible to increase the width of the homogenous layer by simultaneously displacing more than one tubular dispensing means above a substrate. It is also possible to increase the width of the homogenous layer by replacing the substrate holder (the copper table 3), which is displaceable in longitudinal direction, with an XY table, i.e. a substrate holder displaceable in longitudinal direction and width. It is further possible to replace the copper table 3 which rests on a heating plate 8 with a substrate holder provided with a heating element.

1-11. (canceled)

12. A method for applying a layer of a second material to a layer of a nanocrystalline first material, comprising:
providing the layer of the nanocrystalline first material on a horizontal substrate;
providing a liquid containing the second material;
providing a tubular dispensing means comprising a horizontal tube portion provided with lateral outlet openings;
disposing the tubular dispensing means above the layer of the nanocrystalline first material; and
displacing the tubular dispensing means and the layer of the nanocrystalline first material relative to each other in a lateral horizontal direction of the dispensing means, while simultaneously supplying the liquid containing the second material to the tubular dispensing means, such that the liquid flows from the tubular dispensing means onto the layer of the nanocrystalline first material.

13. The method of claim 12, further comprising providing the lateral outlet openings on a top side of the horizontal tube portion generally opposite to a side of the horizontal tube portion facing the horizontal substrate.

14. The method of claim 12, wherein the liquid comprises the second material dissolved in a solvent.

15. The method of claim 12, wherein the liquid comprises the second material in liquid form, and wherein the second material solidifies after being applied to the layer of the nanocrystalline first material.

16. The method of claim 12, further comprising heating the layer of the nanocrystalline first material during the flowing of the liquid onto the layer of the nanocrystalline first material.

17. The method of claim 12, wherein the horizontal tube portion has a circular outer periphery in vertical cross-section.

18. The method of claim 12, wherein the horizontal tube portion comprises a horizontal portion of an L-shaped injection needle.

19. The method of claim 12, wherein the horizontal tube portion has an internal diameter of about 0.4 mm.

20. The method of claim 12, wherein the lateral openings have a diameter of about 0.1 mm.

21. The method of claim 12, wherein the horizontal tube portion comprises a horizontal portion of a U-shaped injection needle.

22. The method of claim 12, further comprising providing the horizontal substrate on a substrate table configured to move relative to the horizontal tube portion in at least one lateral horizontal direction, wherein the horizontal tube portion has a first length, wherein the lateral outlet openings are provided over the first length, wherein a width of the second layer is defined by the first length.

23. The method of claim 22, wherein the substrate table is an XY table configured to move in two mutually orthogonal horizontal directions.

24. The method of claim 12, further comprising adjusting a vertical distance between the horizontal tube portion and the horizontal substrate.

25. A method for forming a second layer onto a nanocrystalline layer disposed on a horizontal substrate, comprising:
providing a liquid containing the second material;
providing a horizontal dispensing tube having a first length at an adjustable height above the horizontal substrate;
providing the horizontal dispensing tube with a plurality of outlet openings that are configured to dispense the liquid therefrom over the first length;
supplying the liquid containing the second material to the horizontal dispensing tube, such that the liquid flows from the plurality of outlet openings onto the horizontal nanocrystalline layer; and
displacing the horizontal dispensing tube and the horizontal nanocrystalline layer relative to each other in a lateral horizontal direction of the horizontal dispensing tube, while simultaneously supplying the liquid containing the second material to the horizontal dispensing tube.

26. The method of claim 25, further comprising arranging the outlet openings on a side of the horizontal dispensing tube generally opposite to a side of the horizontal dispensing tube facing the horizontal nanocrystalline layer, wherein the second layer forms a homogeneous layer.

27. The method of claim 25, further comprising heating the horizontal substrate during the supplying the liquid to the horizontal dispensing tube.

28. The method of claim 25, wherein the horizontal dispensing tube comprises an injection needle having an internal diameter that is substantially larger than a diameter of the outlet openings.

29. The method of claim 28, wherein the internal diameter is about 0.4 mm and the diameter of the outlet openings is about 0.1 mm.

30. The method of claim 25, wherein the horizontal dispensing tube is disposed over a substrate table configured to move relative to the horizontal tube portion in at least one lateral horizontal direction.

31. The method of claim 25, further comprising using a metering pump to provide the liquid to the horizontal dispensing tube, wherein the second layer is provided onto the horizontal nanocrystalline layer in a reproducible and homogeneous manner.
